(19) United States
(12) Patent Application Publication
(10) Pub. No.: US 2026/0359079 A1
(43) Pub. Date: Nov. 12, 2026

(54) SYSTEMS AND METHODS FOR PERSONALIZING USER INTERACTIONS USING HOLOGRAPHIC PROJECTIONS

(71) Applicant: Roland John Shehadeh, Santa Clara, CA (US)

(72) Inventor: Roland John Shehadeh, Santa Clara, CA (US)

(21) Appl. No.: 19/276,476

(22) Filed: Jul. 22, 2025

Related U.S. Application Data
(60) Provisional application No. 63/801,958, filed on May 8, 2025.

(51) Int. Cl. G06F 9/451; G06F 3/04815

(52) U.S. Cl. CPC G06F 9/451; G06F 3/04815

(57) ABSTRACT

are disclosed. A system comprises a mobile device, of a first user, configured to provide a personalized visual representation of a second user contact within a networking platform or through a standalone holographic service. The platform or service is designed for integration with social media applications, cable networks, and compatible hardware for laptops, mobile devices, and televisions to project the holographic visual representations. The system comprises a processing unit to retrieve profile data associated with the second user contact and a user interface to receive a first user input to interact with the personalized visual representation. The system comprises a personalization engine to generate the personalized visual representation of the second user contact. The personalization engine further determines relationship indicators associated with the second user contact and dynamically updates the personalized visual representation by monitoring the relationship indicators.

### CROSS-REFERENCE TO RELATED APPLICATION

This application claims the benefit of the U. S Provisional Patent Application No. 63/801,958 filed on May 8, 2025, the contents of which are incorporated by reference herein.

### FIELD OF THE INVENTION

The present disclosure relates to a digital networking system integrated with holographic projections for enhancing user interactions on social media platforms such as LinkedIn, Facebook, Instagram, and cable networks. The disclosure incorporates open-source protocols to enable users to obtain real-time answers to their questions. More specifically, the disclosure relates to personalization of user interactions in digital communication platforms using artificial intelligence-based and real-time-based visual representations of holographic projections. A controlled fixed state may be used by artificial intelligence for creating or producing entertainment, and social media platforms may use a live state to facilitate real-time communication, video conferencing, and news streaming. The present disclosure also incorporates hardware and optical technologies to project 3D holograms and remains compatible with updates to operating systems.

### BACKGROUND

Networking platforms are essential to facilitate both personal and professional connections in today's digital era. Users frequently engage with contacts across various communication channels, including social media, messaging applications, and collaborative workspaces. The users often tend to lose track of their past engagements, shared experiences, and the evolving nature of their relationships as they interact with numerous contacts. Conventional networking systems provide only static profile representations where users are required to manually recall past interactions and assess whether engaging with a contact is meaningful. This lack of contextual awareness can lead to missed opportunities for meaningful connections and ineffective communication.

A key challenge for users is their inability to make informed decisions before initiating interactions. The users often rely on fragmented memories or scattered profile data. This makes it difficult to assess the relevance of their connection at any given moment. Existing systems primarily display user profiles in text or image-based formats without considering real-time activity, shared experiences, or evolving engagement patterns. As a result, users may struggle to prioritize interactions, maintain meaningful connections, or receive relevant insights about their contacts. Furthermore, traditional platforms do not provide mechanisms to personalize user interactions and optimize relationship-building. Developing advanced systems that provide a dynamic representation of user contact can lead to personalizing and enhancing user interactions. There is a need in the art for ongoing research and development in this field.

### SUMMARY

The disclosed subject matter relates to a system and method for personalizing user interactions using holographic projections. The system comprises a mobile device of a first user configured to provide a personalized visual representation of a second user contact within a networking platform. The system further comprises a processing unit configured to retrieve profile data associated with the second user contact. The system comprises a user interface configured to receive a first user input to interact with the personalized visual representation. The system comprises a personalization engine configured to generate the personalized visual representation of the second user contact based on the retrieved profile data and one or more first user preferences. The personalization engine is further configured to determine one or more relationship indicators associated with the second user contact based on an interaction history between the first user and the second user. The personalization engine is then configured to dynamically update the personalized visual representation by monitoring the one or more relationship indicators.

In an exemplary embodiment, the mobile device is configured to provide the personalized visual representation as a three-dimensional hologram. The processing unit is further configured to retrieve real-time activity data associated with the second user contact from one or more external platforms. In embodiments, the one or more relationship indicators comprise at least one of a communication frequency, shared activities, mutual interests, event participation, and sentiment derived from prior communications. The personalization engine is further configured to modify a visual attribute of the personalized visual representation based on changes to the one or more relationship indicators. The visual attribute includes at least one of a color, size, animation effects, positioning, and graphical overlays representing connection strength between the first user and the second user contact. The personalization engine is configured to dynamically update the personalized visual representation based on user-generated content, shared media, or real-time updates of the second user contact within the networking platform. The personalization engine is further configured to provide one or more recommendations to the first user for improving engagement with the second user contact based on changes in the one or more relationship indicators. The personalization engine is further configured to generate one or more visual indicators within the personalized visual representation to indicate upcoming events, milestones, or recommended actions for further engagement with the second user contact. The personalization engine is further configured to categorize the second user contact based on the one or more relationship indicators.

Another general aspect is a method for personalizing user interactions. The method includes retrieving profile data associated with a second user contact within a networking platform. The method further includes generating, by a personalization engine, a personalized visual representation of the second user contact based on the retrieved profile data and one or more first user preferences. The method includes providing a personalized visual representation of the second user contact on a mobile device of a first user. The method further includes determining one or more relationship indicators associated with the second user contact based on an interaction history between the first user and the second user contact. Further, the method includes dynamically updating the personalized visual representation by monitoring the one or more relationship indicators.

In embodiments, the mobile device is configured to project the personalized visual representation as a three-dimensional hologram. The method further includes retrieving real-time activity data associated with the second user contact from one or more external platforms. The one or more relationship indicators comprise at least one of a communication frequency, shared activities, mutual interests, event participation, and sentiment derived from prior communications. The personalization engine is further configured to modify a visual attribute of the personalized visual representation based on changes to the one or more relationship indicators. The visual attribute includes at least one of a color, size, animation effects, positioning, and graphical overlays representing the evolving connection strength between the first user and the second user contact. The personalization engine is configured to dynamically update the personalized visual representation based on user-generated content, shared media, or real-time updates of the second user contact within the networking platform. The personalization engine is further configured to provide one or more recommendations to the first user for improving engagement with the second user contact based on changes in the one or more relationship indicators. The personalization engine is further configured to generate one or more visual indicators within the personalized visual representation to indicate upcoming events, milestones, or recommended actions for further engagement with the second user contact.

An exemplary embodiment is a non-transitory computer-readable storage medium having data stored therein representing software executable by a computer, the software including instructions that, when executed, cause the non-transitory computer-readable storage medium to perform retrieving profile data associated with a second user contact within a networking platform. The instructions further cause the computer-readable storage medium to perform generating a personalized visual representation of the second user contact based on the retrieved profile data and one or more first user preferences and providing a personalized visual representation of a second user contact on a mobile device of a first user. The instructions further cause the computer-readable storage medium to perform determining one or more relationship indicators associated with the second user contact based on an interaction history between the first user and the second user contact and dynamically updating the personalized visual representation by monitoring the one or more relationship indicators.

### BRIEF DESCRIPTION OF THE DRAWINGS

FIG. 1 is a schematic illustration of a system for personalizing user interactions.

FIG. 2 is an illustration of main components of a user interaction personalization system in an embodiment of the disclosed subject matter.

FIG. 3 is a flow diagram of a process for personalizing user interactions.

FIG. 4 is a schematic illustrating selection of a second user contact on a first user's mobile device in an embodiment of the disclosed subject matter.

FIG. 5A is a schematic illustrating a personalized visual representation of the second user contact in an embodiment of the disclosed subject matter.

FIG. 5B is a schematic illustrating a personalized visual representation of the second user contact with emotional impressions in an embodiment of the disclosed subject matter.

FIG. 6 is a schematic illustrating relationship indicators influencing connection between the first user and the second user contact in an embodiment of the disclosed subject matter.

FIG. 7 is a schematic illustration of a graph representing trends in relationship indicators in an embodiment of the disclosed subject matter.

FIG. 8 is a schematic illustrating a screenshot of personalized recommendations to improve interaction between the first user and the second user contact in an embodiment of the disclosed subject matter.

FIG. 9 is a schematic of a computer system that may implement an embodiment of the disclosed subject matter.

### DETAILED DESCRIPTION

The disclosed subject matter relates to a method and system for personalizing user interactions within digital networking platforms using holographic projections. For example, the digital networking platforms may include LinkedIn, Facebook, Instagram, or any social media networking platform. The disclosed system is implemented to generate personalized visual representations, including three-dimensional holograms, of users or individuals on the digital networking platforms. For instance, the personalized visual representation of a second user contact may be presented to a first user. This personalized visual representation is based on profile data of the second user contact, the first user preferences, and relationship indicators. The system is thus configured to transform impersonal contact lists into engaging and interactive experiences that facilitate meaningful connections.

The system utilizes holographic projection technology integrated with mobile devices to enable a more tangible and immersive interaction between users. The holographic image may be displayed in a live state, projecting in real time the presence of another user, such as a new acquaintance. In some embodiments, the system may also utilize artificial intelligence and machine learning models to generate predictive or synthetic holographic projections on demand. For example, providing visualizations of individuals or anticipated behaviors derived from available data, even when specific identity details are unknown.

In embodiments, for personalizing user interactions using holographic projections, the screen of a mobile device, laptop, or desktop utilizes stereoscopic techniques to simulate a three-dimensional (3D) image from a two-dimensional (2D) image. This stereoscopic rendering enables the mobile device or a portable device to project a lifelike, touch-interactive hologram and enhances the emotional impact of digital interactions. By using stereoscopic display technology, the system creates a realistic interface that allows users to perceive and interact with holographic representations of their contacts. This adds depth and personalization to conventional communication on networking platforms.

In embodiments, the system incorporates an open-source, query-based protocol, facilitating broad compatibility, transparency, and extensibility across diverse applications. This protocol allows structured and intelligent searches for users, social groups, corporations, educational institutions, or government entities, and supports secure and controlled data exchange based on individual preferences.

In an exemplary embodiment, the first user is an individual operating a mobile device and actively seeking to connect with one or more second user contacts within a networking platform. The first user interacts with the personalized visual representation generated by the system and receives recommendations to enhance their engagement with contacts. The first user is the primary actor who initiates, monitors, and acts on the personalized engagement strategies provided by the system. In embodiments, the second user contact is the individual with whom the first user is intended to connect and whose profile data is retrieved and processed by the system to create a personalized visual representation. This second user contact's profile details and real-time activity data are analyzed to determine relationship indicators such as communication frequency, shared activities, mutual interests, event participation, and sentiment. The system uses this information to generate an interactive visual or holographic display, allowing the first user to better understand before engaging with the second user contact.

Unlike conventional social media platforms, where user interactions are often superficial and text-based, the disclosed system adopts a relationship-centric approach. The disclosed system uses a design and search structure that provides a starting point based on what the user is intentionally searching for, rather than offering random or arbitrary suggestions. The system enables users to connect based on real-life goals, shared interests, and personal or professional backgrounds. Instead of generating random or unrelated suggestions, the system allows users to search and discover connections through clear, intentional actions. An acquaintance can develop into a trusted connection through transparent visibility into mutual connections, work profiles, aspirations, goals, and the potential to be a positive influence in one another's lives and social circles. This structured approach to discovering meaningful contacts helps create relevant and trusted relationships by providing a more personal and memorable experience. By functioning as a transparent, intent-driven platform, the system builds trust and reliability by positioning itself as a preferred networking platform that is safe, interactive, entertaining, and suitable for daily use.

In embodiments, the system initiates aggregation of data related to the second user contact from multiple sources. The system comprises a processing unit that retrieves static profile data and real-time activity data from various platforms. For instance, the static profile data, such as the second user contact's name, career information, educational background, and personal interests, are retrieved from the networking platform. The real-time activity data is retrieved from one or more external platforms. In some embodiments, the processing unit incorporates filtering techniques to eliminate redundant and erroneous data to obtain a clean dataset for subsequent processing.

In embodiments, the system comprises a personalization engine to process the collected data combined with one or more first-user preferences. The personalization engine uses Artificial intelligence (AI)-driven algorithms to analyze profile data, real-time activity data, and historical interaction patterns. Based on the analysis, the personalization engine generates a personalized visual representation of the second user contact. The personalized visual representation is customized to the specific interests and needs of the first user. The personalization engine not only creates a static image of the second user contact but, in some embodiments, can render this visual representation as a three-dimensional hologram.

The personalized visual representation is generated to be both informative and dynamic. The personalized visual representation integrates multiple elements such as the contact's profile picture, career updates, recent activity logs, and other key details. The system is capable of providing the visual representation on the mobile device's screen or as a holographic display. The visual representation includes one or more interactive components. For instance, the interactive components of the invention include a user interface, which enables the first user to provide input through touch gestures, voice commands, or other input methods to select or modify the personalized visual representation. In some embodiments, the three-dimensional hologram serves the interactive component by allowing the first user to engage with, view, and explore detailed information about the second user contact. The dynamic nature of the personalized visual representation is represented by an example where new data is received, such as a change in the contact's job status or recent social activity. The visual representation updates in real-time to reflect these changes accurately.

In an exemplary embodiment of the disclosed system, the personalization engine determines one or more relationship indicators between the first user and the second user contact. The one or more relationship indicators include communication frequency, shared activities, mutual interests, event participation, and sentiment analysis derived from previous interactions. The system uses these metrics to evaluate the strength and quality of the relationship between the first user and the second user contact. The personalization engine compares current indicators with historical data to identify trends. For example, the trends may include increasing interaction or emerging common interests that provide a constructive view of the relationship over time.

In embodiments, the personalization engine monitors the relationship indicators and automatically modifies the visual representation. As the relationship indicators evolve, whether through increased communication frequency, new shared activities, or shifting sentiments, the personalization engine automatically modifies the visual representation associated with the second user contact. For example, these modifications include adjustments to visual attributes such as color changes (indicating connection strength), size variations, animation effects, positioning, and inclusion of graphical overlays that highlight important updates. This continuous feedback loop allows the first user to continuously understand a real-time reflection of their relationship with the second user contact.

The system comprises an interactive user interface that enables the first user to engage directly with the personalized visual representation. For example, the user interface may be an interface of the mobile device associated with the first user. The user interface captures various forms of input, including touch gestures, voice commands, and gesture-based interactions from the first user. Through this user interface, the first user can select a contact to view more detailed information, request updates, and interact with recommendations generated by the system. Using a voice command, for example, the first user may locate a LinkedIn connection and project that contact's hologram, which includes their professional biography, education history, future career aspirations, and any recent updates, all instantly visualized for ease of recall and interaction.

In some embodiments, the system generates one or more personalized recommendations for the first user. Based on the analyzed relationship indicators and historical interaction patterns, the system suggests specific actions that could enhance engagement with the second user contact. For instance, if communication frequency has declined, the system might recommend sending a personalized message or scheduling a meeting. Similarly, if shared activities have increased, the system may suggest planning a joint event. These recommendations are displayed directly on the mobile device's interface so that the first user can act on suggestions immediately.

Another embodiment of the system includes a mechanism to categorize the second user contacts based on the analyzed relationship indicators. The system classifies the second user contacts into categories such as close connections, professional contacts, or casual connections, to assist the user in prioritizing their interactions. This categorization is visually integrated into the personalized visual representation through distinct graphical elements or overlays that indicate the importance or strength of the connection.

In various embodiments, the disclosed system is implemented to enhance user interactions within networking platforms such as LinkedIn, Facebook, and Instagram by projecting personalized three-dimensional holographic representations of connected users. The system includes a mobile application integrated with a mobile device and associated hardware capable of projecting a hologram directly from the mobile device. This holographic projection allows users to experience a more tangible and memorable connection, transforming social media interactions from abstract connections into vivid, personal experiences.

The system addresses a major challenge across social media platforms, where the lack of personalization has led to decreased user engagement over time. Social media has increasingly become impersonal and disconnected from natural human interaction. The disclosed hologram-based system introduces a personal, lifelike element to these interactions, offering users lasting emotional impressions of their contacts. The system addresses this key limitation in traditional social networking by providing visual and emotional depth to each connection. By representing intangible digital contacts as lifelike holograms that can be projected on demand, individuals are able to build recognizable, lasting impressions of who their contacts are. For instance, a voice command or touch interaction may instantly surface the individual's professional history, affiliations, interests, and social context, all via a visual medium. This overcomes the limitations of traditional social media feeds, which tend to reduce user interaction due to their impersonal and text-heavy nature. By restoring familiarity and identity to digital profiles, the system promotes consistent and emotionally intelligent interactions. This personalization also helps solve a common issue on traditional social media platforms, where users often find that no one has posted or interacted in years. By providing a more engaging and lifelike way to connect, the system encourages regular, meaningful use of the platform as part of users'daily lives.

The personalized visual representation, generated by the personalization engine, creates a visual and emotional impression of second user contacts and provides professional and personal networking. The holographic system may incorporate social matching algorithms, enabling users to preview a 3D holographic representation of potential connections before establishing a connection. Real-time holographic updates based on shared activities and event participation can further deepen interactions. For instance, users attending events such as concerts or meetings can update and share their holographic status, allowing for dynamic social coordination.

In addition to social media integration, the system can enhance virtual meetings by projecting three-dimensional holographic avatars, improving engagement, and providing a more meaningful meeting experience. The personalization engine may allow users to customize visual attributes such as color and design elements of the holographic projection, providing a more realistic and personalized visual experience. The disclosed system addresses a longstanding limitation in conventional social media platforms, which often lack personal engagement and emotional connection. By incorporating holographic technology, the system offers a more natural, human-centric method of interaction, promoting deeper relationships and improving user retention. Voice-controlled commands may be incorporated to locate and project a specific contact's hologram, along with contextual information such as professional background, educational history, career objectives, and recent activities. Similar features extend to personal platforms such as Instagram and Facebook, allowing a first user and a second user contact to immediately connect and engage through intuitive voice or touch controls. Further, the three-dimensional hologram technology can be utilized across various media platforms, including cable networks and streaming services like YouTube TV, for improving the viewing experience of movies, shows, and news broadcasts.

Although the system primarily focuses on improving social networking and user interactions, the system's functionality extends to various other fields. In academic settings, for example, the system can help university administrators and students build meaningful connections from their campus experience. In professional contexts, such as networking on LinkedIn, it can bridge the gap between static profiles and dynamic interactions, providing a tangible and memorable way to understand and engage with connections. In some embodiments, the system is adaptable for use in government, surveillance, campus safety, and emergency response scenarios, where real-time personalized data can facilitate rapid decision-making and effective communication.

For example, the system may enable the mobile device to transmit an emergency alert directly to local law enforcement dispatch centers, bypassing the need for traditional campus emergency stations. A precise holographic projection of the user's location can be activated, enabling immediate response to incidents or crimes in progress. In educational settings, the platform facilitates social connections among students, particularly during transitional periods such as freshman year, by providing personalized holographic representations and interaction opportunities. Similarly, in medical environments, the system can support physicians connecting with future colleagues prior to beginning residencies or fellowships, encouraging early collaboration and support networks. The system may serve as a valuable resource for individuals managing health conditions by enabling connections with others who share similar medical concerns, thus building a personalized support database. Further, in cultural contexts, the system allows users to seek answers and build relationships across diverse or shared ethnic backgrounds, improving the quality and credibility of information exchange. Within the political sphere, the platform may be utilized to strengthen diplomatic relationships, allowing ambassadors and leaders to form more personalized and meaningful connections across sovereign nations. The disclosed system and platform thus aim to bridge social gaps, facilitate meaningful connections, and promote collective well-being, providing a transformative solution to the isolation and fragmentation characteristic of conventional communication platforms.

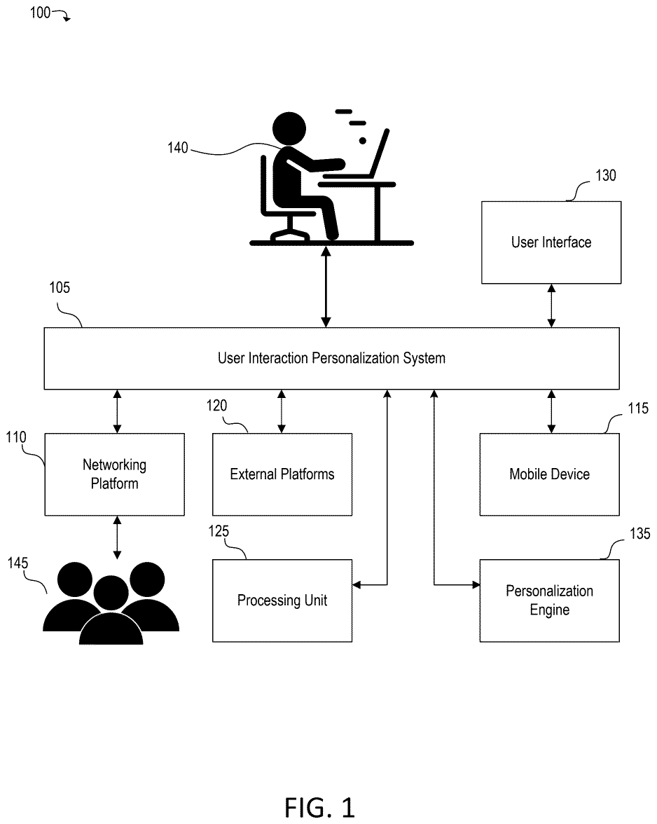

Representative embodiments according to the disclosed subject matter are shown in FIGS. 1 to 9. The specific embodiments are meant to be illustrative and not limited to the scope of the disclosed subject matter and the various ways it may be embodied.

Referring to FIG. 1, FIG. 1 is a schematic illustration of a system 100 for personalizing user interactions. The system 100 comprises a user interaction personalization system 105, a networking platform 110, a mobile device 115, one or more external platforms 120, a processing unit 125, a user interface 130, and a personalization engine 135. In embodiments, the user interaction personalization system 105 may be integrated with the mobile device 115, a user interface 130, a networking platform 110 and the one or more external platforms 120, via a network interface or a communication interface.

The user interaction personalization system 105 is a central framework that integrates all components to personalized visual representations of a second user contact to a first user 140. The user interaction personalization system 105 coordinates the flow of data from various sources and components. The system not only aggregates information from diverse sources but also ensures that the data is processed in a timely and accurate manner. It acts as a crucial component for generating interactive visual representations, such as three-dimensional holograms, and facilitates real-time updates based on continuous monitoring of relationship indicators. In some embodiments, the user interaction personalization system 105 is a holographic projection system. This user interaction personalization system 105 allows the first user 140 to experience a personalized interface that evolves dynamically as new data and interactions occur.

The networking platform 110 is configured to enable interactions between the first user 140 and the second user contact 145. For instance, the first user 140 initiates an interaction with the second user contact 145 via the networking platform 110. In one example, the networking platform 110 is a social media platform such as LinkedIn, Facebook, or Instagram or any digital services platform that enables individuals to interact with other users.

In embodiment, the networking platform 110 serves as a primary repository for static profile data associated with the second user contact 145. The profile data comprises background information such as names, job titles, educational histories, and personal interests of the second user contact 145. Represented by widely used social media or professional networking sites like LinkedIn, Facebook, or Instagram, the networking platform 110 aggregates publicly available and the second user-submitted information that represents an individual's professional and personal identity. The system creates an initial profile using this information, which is later enhanced by dynamic, real-time updates. The networking platform 110 stores historical records and metadata that are crucial for establishing the context of a relationship between the first user and the second user contact. These records include past communication logs, event participation, shared activities, and other engagement metrics that capture the long-term evolution of the relationship.

The external platforms 120 are configured to provide real-time activity data of the second user contact 145. For instance, the real-time activity data includes recent posts, check-ins, event participations, and other timely social interactions that reflect the second user's current status. For example, the external platforms 120 may include Twitter, YouTube, Reddit, and other community platforms. The integration of the external platforms 120 allows the system to capture a broader spectrum of the second user contact's behavior. This includes sentiment analysis from recent interactions, immediate updates on location or event participation, and other contextual details. By aggregating this dynamic data, the system can provide a more accurate and updated visual representation that reflects the evolving activities and engagement patterns of the second user contact 145.

The processing unit 125 is configured to retrieve profile data and real time activity data associated with the second user contact 145. The real time activity data comprises dynamic information that reflects the current status and engagement of the second user contact 145. This includes, for example, posts, status updates, photos, videos, and stories shared on social media, check-ins and location data from location-based services, live engagement metrics such as likes, comments, shares, and retweets, and participation details in events or trending topics. Further, the real time activity data comprises streaming content, real-time analytics of the second user contact's interactions, and other real time updates that provide a current snapshot of the second user contact's online behavior and activity.

In some embodiments, the processing unit 125 is further configured to aggregate, synchronize, and filter data from both the networking platform 110 and the external platforms 120. In embodiments, the processing unit 125 collects static and dynamic datasets, then applies advanced filtering algorithms to remove duplicates, resolve conflicts, and eliminate erroneous information. This ensures that the dataset delivered to the personalization engine is clean, reliable, and optimized for further processing.

The mobile device 115 is a primary interface through which the first user 140 interacts with the system. The mobile device 115 is configured to display the personalized visual representation of the second user contact 145, either as a conventional digital display or as a three-dimensional hologram. The mobile device's hardware and software work together so that visualizations are rendered accurately and responsively and provide an improved user experience. For example, the mobile device 115 may include a desktop or laptop computer, tablet, smartphone, wearable devices, voice-controlled devices, and the like.

In embodiments, the mobile device 115 is configured to capture inputs such as touch gestures, voice commands, and even gesture-based interactions from the first user 140. These inputs drive interactivity by allowing the first user 140 to navigate through different views, select specific contacts, and engage with recommendations provided by the system. In some embodiments, the mobile device 115 may allow the second user contact 145 to provide inputs such as approval of a connection request, voice commands, and the like. In embodiments of holographic projections, the mobile device 115 may include projection technology that enables the visualization to extend into the physical space to create a tangible and memorable connection between the first user 140 and the second user contact 145.

The user interface 130 is an interactive layer that allows the first user 140 to engage with the personalized visual representation. The user interface 130 captures various forms of the first user input and translates them into commands that modify or improve the visual display. The user interface 130 further supports multiple input modalities, including touchscreen interactions, voice recognition, and gesture controls.

In embodiments, the user interface 130 provides system-generated recommendations and updates in a clear and actionable format. When the personalization engine identifies changes in relationship indicators or updates in the second user contact's profile, these are promptly reflected on the user interface 130. The user interface may include visual elements such as buttons, menus, and pop-up notifications that prompt the first user 140 to take specific actions like sending a message, congratulating on a milestone, or scheduling a meeting. The user interface 130 confirms that the first user 140 is aware of the latest information to engage more effectively with the second user contact 145.

The first user 140 is an individual who actively operates the mobile device 115 and engages with the user interaction personalization system 105. The first user 140 may seek to initiate interactions with other individuals; for example, second user contacts on the networking platform 110. The first user 140 initiates, monitors, and interacts with the personalized visual representations generated by the system. Their preferences, historical interaction patterns, and current engagement behavior drive the dynamic processing within the personalization engine 135. The first user 140 is a primary actor who inputs commands through touch gestures, voice commands, or other interaction methods to access detailed information, update the display, or act upon engagement recommendations. The active participation of the first user 140 is essential for refining the personalized visual representation so that it remains aligned with their specific interests and needs.

The second user contact 145 may be the individual whose profile data and activity information are processed to generate the personalized visual representation and displayed to the first user 140. This second user contact's static profile details, such as name, job title, educational background, and personal interests, are retrieved from the networking platform 110, and dynamic updates, including real-time social activity and event participation, are gathered from the external platforms 120. The system analyzes this dataset to create an interactive depiction of the contact, which may be displayed as a digital image or a three-dimensional hologram. The visual representation reflects not only the current status of the second user contact 145 but also the historical context of their interactions with the first user 140. The system enables the first user 140 to gain a complete understanding of the second user contact 145 and facilitates informed engagement and more meaningful connections.

The personalization engine 135 is a key component of the system that transforms raw data into the personalized visual representation of the second user contact 145. The personalization engine 135 is configured to analyze profile data, real-time activity updates, and user preferences to generate and maintain the personalized visual representation of the second user contact 145. The personalization engine 135 not only creates an initial representation based on static and dynamic information but also continuously updates the representation by monitoring various relationship indicators.

The personalization engine 135 utilizes data aggregated by the processing unit 125, which collects static profile information from the networking platform 110 and real-time updates from external platforms 120. Examples of static data include names, career histories, educational backgrounds, and interests, while real-time activity data may include recent posts, event participations, location check-ins, and other updates relevant to the second user contact's current status. In addition to profile data, the personalization engine 135 considers the first user 140 preferences (such as interest categories and display style) and past interaction histories (for example, message exchanges and event collaborations) for generation of the visual representation. By combining these datasets, the personalization engine 135 identifies a holistic view of both the second user contact's profile and the evolving nature of the first user's relationship with that contact.

The personalization engine 135 generates the initial personalized visual representation upon aggregating the data. The personalized visual representation is not static, it is implemented to be both informative and dynamic. The personalization engine 135 uses data processing techniques to transform the retrieved information into a visual format that may be displayed as a digital image or, in enhanced embodiments, as a three-dimensional hologram. This visual representation integrates elements such as the second user contact's profile picture, career updates, recent activity logs, and other relevant details.

The personalization engine 135 further determines one or more relationship indicators between the first user 140 and the second user contact 145. For example, the relationship indicators are measurable metrics that reflect the quality, depth, and evolution of interactions between users. The relationship indicators may include frequency and intensity of communications, the degree of shared activities and mutual interests, participation in events, and sentiment derived from past communications. The personalization engine 135 maps these indicators onto specific visual attributes. For instance, the visual attributes may include variations in color, size, animation effects, or graphical overlays applied to reflect changes in connection strength or engagement level. The visual attributes provide the first user 140 with an intuitive, real-time insight into the evolving relationship.

The personalization engine 135 continuously monitors incoming data and dynamically updates the personalized visual representation to reflect any changes. As relationship indicators fluctuate, whether due to increased interaction, new shared activities, or shifting sentiments, the personalization engine 135 adjusts the visual representation accordingly. This dynamic updating mechanism enables the representation to remain updated and accurately reflects the latest state of the contact's profile and activity. Further, the personalization engine 135 generates targeted recommendations for the first user 140, suggesting actionable steps such as sending a message or planning an event with the second user contact 145 to improve engagement.

The personalization engine 135 categorizes the second user contact 145 based on the analyzed relationship indicators. This categorization may group contacts as “close connections,” “professional contacts,” or “casual acquaintances.” The personalization engine 135 can overlay distinct graphical elements to convey these categories and thus helps the first user quickly prioritize interactions. In embodiments, the personalization engine 135 not only provides a detailed and interactive visualization but also serves as the decision-making hub that improves user engagement by delivering timely, context-aware recommendations.

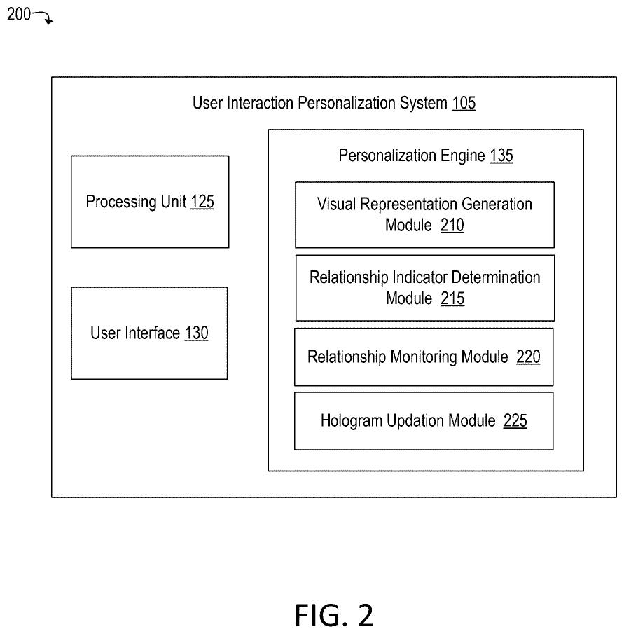

Referring to FIG. 2, FIG. 2 is an illustration of main components of the user interaction personalization system 105 in an embodiment of the disclosed subject matter. The figure depicts a block diagram 200 of the user interaction personalization system 105 with various components.

The user interaction personalization system 105 comprises a personalization engine 135 configured to improve interactions between a first user and a second user contact using a personalized visual representation of the second user contact. The personalization engine 135 further includes one or more modules comprising a visual representation generation module 210, a relationship indicator determination module 215, a relationship monitoring module 220, and a hologram updation module 225. The one or more modules interact with each other via a network interface or a communication interface. In embodiments, an output generated by each module may be used by the one or more other modules to achieve an end result of the personalized visual representation.

The one or more modules interact with a processing unit 125 and a user interface 130. The processing unit 125 is configured to gather and refine data before it reaches the personalization engine 135. The processing unit 125 retrieves static profile information of the second user contact from a networking platform and real-time activity updates from external platforms. This combined data set may include static attributes such as name, job title, and interests, as well as dynamic updates such as recent posts, event participation, or location check-ins. The processing unit 125 aggregates data from multiple sources by eliminating duplicates or inconsistencies through filtering techniques. By integrating both static and dynamic data, the processing unit 125 provides an explanatory view of the second user contact's profile and activities. This enables the personalization engine 135 to generate an accurate visual representation of the second user contact.

The user interface 130 is a primary interactive layer through which the first user accesses the system. The user interface 130 interprets various inputs and enables the first user to select the second user contact, request additional information, and provide preferences that influence how data is displayed. In embodiments where the personalized visual representation is provided as three-dimensional hologram, the user interface 130 may offer specialized controls for rotating, zooming, or otherwise interacting with the holographic representation. Any updates triggered by the personalization engine 135, for instance, changes in relationship indicators or newly retrieved data are immediately reflected on the user interface 130.

The major component of the user interaction personalization system 105 is the personalization engine 135 configured to transform raw data into a dynamically updated, personalized visual representation of the second user contact. Each module within the personalization engine 135, including the visual representation generation module 210, the relationship indicator determination module 215, the relationship monitoring module 220, and the hologram updation module 225, collaborates with the processing unit 125 and the user interface 130 to deliver a seamless experience.

The visual representation generation module 210 is configured to combine the refined dataset provided by the processing unit 125 with the first user's preferences to create an initial visual representation of the second user contact. This process includes integrating essential profile details such as the second user contact's profile picture, career updates, and recent activity logs into a visual representation. In embodiments that support real-time updates, the visual representation generation module 210 may also incorporate user-generated content or shared media of the second user contact so that the depiction reflects the most current information available from various sources.

The visual representation generation module 210 is further configured to personalize the visual representation based on the first user's preferences after the initial rendering. This customization may include selecting the attributes to emphasize, adjusting the layout, or arranging the information in a manner that aligns with the desired visual style. The output is a contextual visual display that can be rendered either as a digital image or as a three-dimensional hologram, depending on the capabilities of the mobile device of the first user.

The relationship indicator determination module 215 is configured to determine one or more relationship indicators associated with the second user contact based on the interaction history between the first user and the second user contact. For instance, the one or more relationship indicators may include communication frequency, shared activities, mutual interests, event participation, and sentiment analysis. The relationship indicator determination module 215 processes both historical and real-time data to determine the strength and quality of the connection between the first user and the second user contact. By comparing current values of the relationship indicators with historical trends, this module identifies significant shifts, such as increased communication or the emergence of new common interests to understand the evolving dynamics of the relationship.

The relationship monitoring module 220 plays an important role in maintaining the system's responsiveness. Once relationship indicators are computed, the relationship monitoring module 220 continuously tracks any changes in these metrics. If new data suggests that metrics like communication frequency or sentiment have shifted, this module promptly updates the corresponding relationship indicators. This feedback is continuously sent to the personalization engine 135 to utilize the current information and allow real-time adjustments to the personalized visual representation.

Upon detecting significant changes in the relationship indicators such as a spike in mutual interests or a drop in communication, the relationship monitoring module 220 triggers the personalization engine 135 to modify the personalized visual representation. These modifications may involve adjustments to visual attributes like color, size, animation effects, or the addition of graphical overlays. Such real-time updates ensure that the visual representation remains adaptive and reflects the evolving nature of the relationship. This helps to provide the first user with immediate and intuitive insights into their connection with the second user contact.

The hologram updation module 225 is configured to manage the creation and continuous update of the three-dimensional visual representation of the second user contact. This module is configured to render the hologram with appropriate depth and perspective. The hologram updation module 225 is further configured to integrate one or more interactive features into the visual representation to allow the first user to rotate, zoom, or otherwise explore specific details of the second user contact. By incorporating these interactive elements, the hologram updation module 225 improves the quality of the holographic display and makes digital interactions more realistic and engaging.

The hologram updation module 225 continuously synchronizes the holographic visual representation with real-time data and the relationship indicators. As the relationship monitoring module 220 flags updates, the hologram updation module 225 adjusts the hologram's appearance accordingly. For example, altering color gradients to reflect increased engagement levels or adding icons to indicate upcoming events, milestones, and recommended actions as visual indicators. This process of real-time synchronization ensures that the hologram provides an accurate and dynamic representation of the second user contact's current status and the evolving relationship. This provides the first user with a tangible and up-to-date interactive experience.

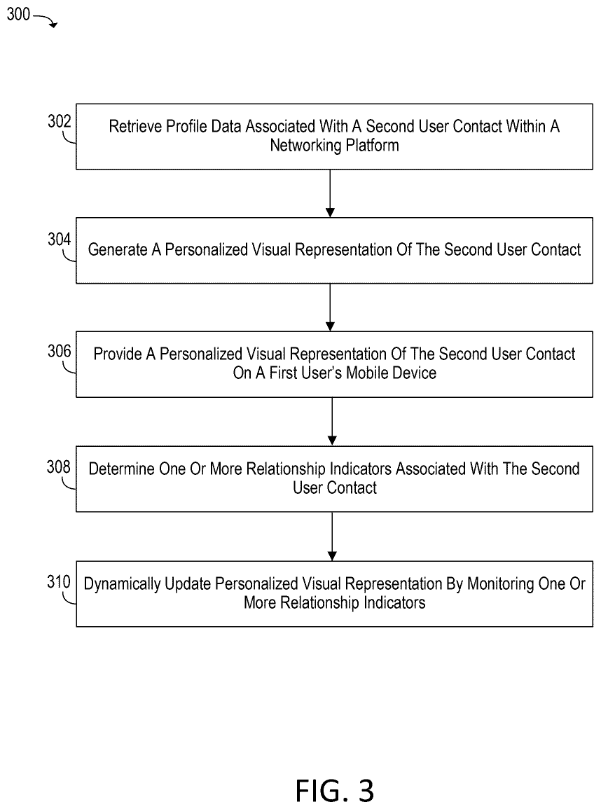

Referring to FIG. 3, FIG. 3 is a flow diagram of a process for personalizing user interactions. The process of the flow diagram 300 may be implemented to personalize interactions between a first user and a second user contact using a personalized visual representation of the second user contact. For instance, the personalized visual representation may include a three-dimensional hologram.

At step 302 of the flow diagram 300, the process retrieves profile data associated with a second user contact from a networking platform. In this step, the process collects static profile details such as the second user contact's name, job title, educational background, and personal interests, that are stored on social media or professional networking platforms like LinkedIn, Facebook, or Instagram. The process further retrieves real-time activity data from external platforms, such as Twitter, Instagram feeds, location-based services, and other third-party platforms. This dynamic data may comprise recent posts, event participation, check-ins, and live status updates that provide a current status of the second user contact's activities. By aggregating both static and dynamic data, the process builds a profile for the second user contact.

At step 304, the process generates a personalized visual representation of the second user contact. Once the data is retrieved and processed, the process combines the filtered dataset with one or more first-user preferences to generate an initial personalized visual representation of the second-user contact. This visual representation integrates various elements, including the second user contact's profile picture, career updates, and recent activity logs. The process uses AI-driven algorithms to analyze both the static data from the networking platform and the real-time data from external platforms and generates the personalized visual representation of the second user contact.

At step 306, the process provides the generated visual representation to the first user via the mobile device. The mobile device provides an interactive interface and displays the personalized visual representation as a digital image or as a three-dimensional hologram, depending on the device's capabilities. The user interface on the mobile device captures input from the first user, such as touch gestures, voice commands, or gesture-based interactions, and allows the user to select the second user contact, request additional details, or modify display settings.

At step 308, the process determines one or more relationship indicators between the first user and the second user contact based on the interaction history between the first user and the second user contact. The relationship indicators may include communication frequency, shared activities, mutual interests, event participation, and sentiment derived from prior communications, that provide a quantitative and qualitative measure of the relationship. The process analyzes historical interaction data and current activity metrics to identify trends such as increases in communication or emerging common interests. Using this analysis, the process evaluates the overall strength of the connection between the first user and the second user contact. This analysis customizes the visual representation and ensures that the display reflects not only static information but also the evolving nature of the user relationship.

At step 310, the process dynamically updates the personalized visual representation based on the monitored relationship indicators. As new data is received from both static profiles and real-time external platforms, the process re-evaluates metrics such as communication frequency, shared activities, mutual interests, event participation, and sentiment analysis. These evaluations trigger immediate modifications to visual attributes including changes in color, size, animation effects, and the addition of graphical overlays to the personalized visual representation. These adaptive updates not only inform the first user about evolving engagement levels but also provide actionable recommendations, such as prompting a message or suggesting a joint activity, to facilitate deeper interactions.

In embodiments, the process integrates holographic projection to present a three-dimensional representation of the second user contact. The process synchronizes real-time data with the hologram by updating its visual attributes and interactive features as the relationship indicators change. This continuous feedback ensures that the holographic representation remains up-to-date and contextually accurate and provides the first user with an engaging interactive experience.

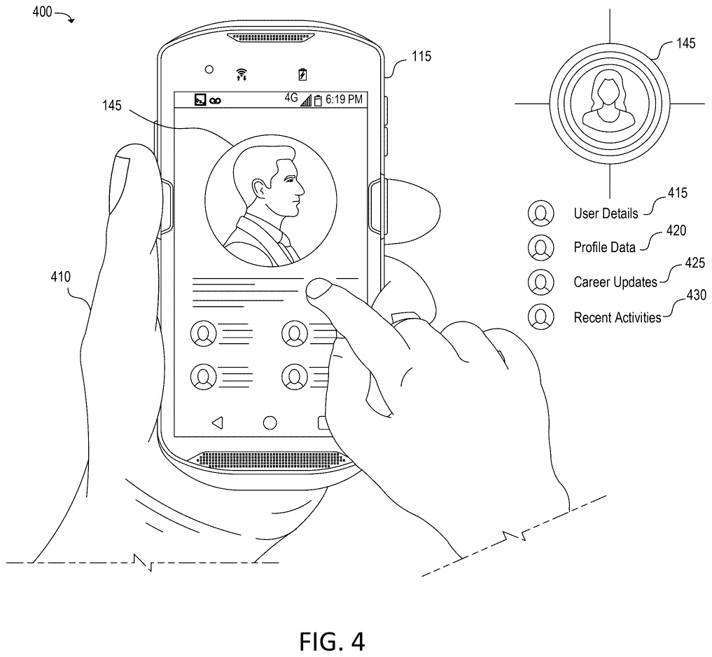

Referring to FIG. 4, FIG. 4 is a schematic illustrating selection of a second user contact on a first user's mobile device in an embodiment of the disclosed subject matter. FIG. 4 depicts scenario 400 in which a first user interacts with a user interaction personalization system via a mobile device 115.

The first user may select a second user contact 145 displayed on the mobile device 115. For instance, hands 410 of the first user are depicted in the figure to illustrate the selection of the second user contact 145 within the networking platform. The mobile device 115 interface provides touch-based interaction to the first user to select or modify how the second user contact's information is presented on the mobile device 115.

As the first user taps on the second user contact's profile pictures or related icons, the system retrieves one or more details, relationship indicators, or engagement recommendations associated with that second user contact 145. The one or more details include user details 415, profile data 420, career updates 425, and recent activities 430 of the second user contact 145. The second user contact 145 is shown as a circular profile image on the mobile device 115 screen. Adjacent or beneath the profile image, textual or icon-based elements indicating the user details 415, the profile data 420, the career updates 425, and the recent activities 430 are displayed to reflect both static and dynamic information.

These icons indicate a structured approach to present the second user contact's information and allow the first user to drill down into specific categories with a simple touch. The first user's ability to select or modify these elements demonstrates how the system personalizes the content based on the first user's preferences. The user details 415 icon comprises basic personal information of the second user contact 145, including key identifiers such as their name and profile photo. This icon serves as a primary means for the first user to quickly recognize and identify the second user contact facilitating an immediate connection. The profile data 420 icon provides static background details about the second user contact 145, such as educational history and geographical location. This icon offers a context for the first user to gain insight into the second user contact's long-term attributes and personal background.

The career updates 425 icon captures real-time or recent professional changes related to the second user contact 145. This icon ensures that any modifications in employment status, job role, or professional achievements are promptly reflected in the visual representation, keeping the information current and relevant. The recent activities 430 icon comprises a continuously updated feed that displays the second user contact's social posts, event participation, and location check-ins. This icon provides a live update of the second user contact's current engagements and interactions by adding a dynamic layer to the overall profile that enhances the first user's understanding of their recent activity.

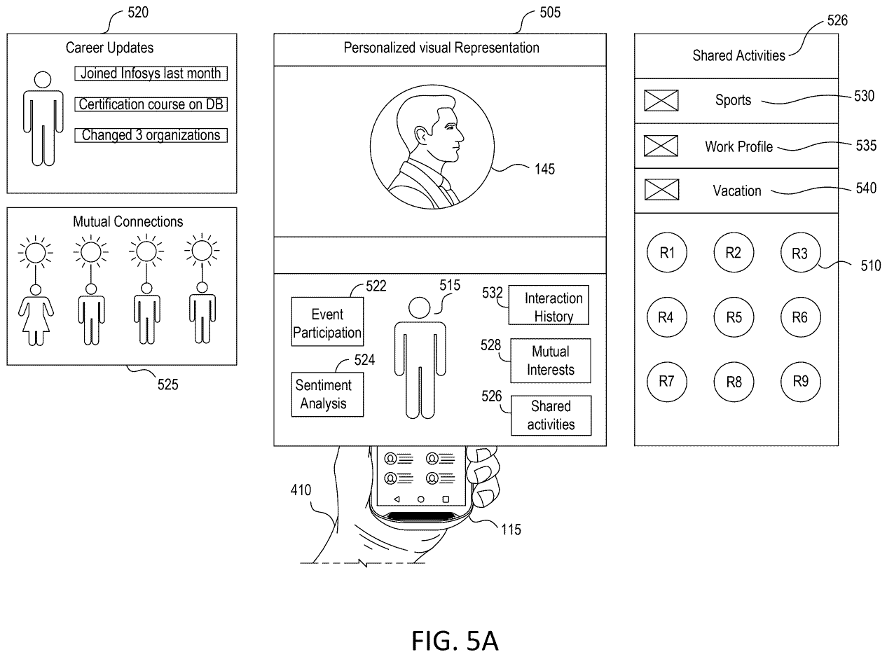

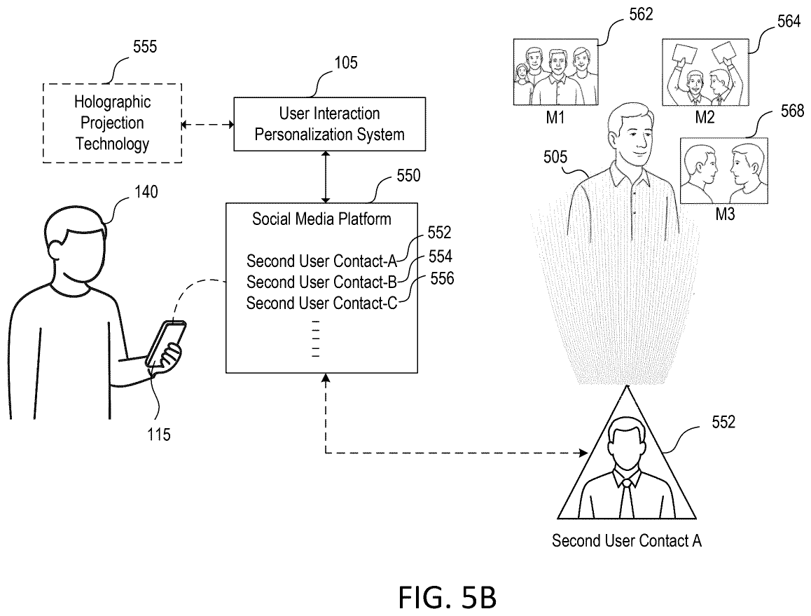

Referring to FIG. 5A, FIG. 5A is a schematic illustrating a personalized visual representation of the second user contact in an embodiment of the disclosed subject matter. In embodiments, the figure illustrates the projection of a personalized visual representation 505 of the second user contact 145 and highlights the identification of relationship indicators 510.

The mobile device of the first user is equipped with a projection technology that converts the digitally generated three-dimensional visual representation into a tangible hologram. In embodiments, this is achieved using an integrated system of micro-optics and spatial light modulators, which may work in combination with a precise optical assembly to create the illusion of depth and volumetric imagery. The projected hologram can be viewable from multiple angles and provide an enhanced experience without the need for specialized viewing equipment.

In this figure, a center section labeled personalized visual representation 505 depicts an image of second user contact 145 as a central figure, surrounded by multiple informational panels. These panels reflect both static data (for example, profile details) and dynamic data (for example, recent professional changes and new shared activities) that the system retrieves from networking and external platforms. For example, a career updates 520 panel lists recent job transitions and certifications, while a mutual connections 525 panel visually indicates one or more contacts that both the first user and second user contact share.

The personalized visual representation 505 further includes a three-dimensional representation 515 of the second user contact 145 including one or more relationship indicators. The one or more relationship indicators include event participation 522, sentiment analysis 524, shared activities 526, mutual interest 528, and interaction history 532. The event participation 522 indicator tracks occasions where both the first user and the second user contact were present and provides contextual recommendations regarding past or upcoming events. The sentiment analysis 524 indicator evaluates the emotional tone of past communications and helps to refine how the system personalizes interactions.

The interaction history 532, mutual interests 528, and shared activities 526 indicators further improve the representation by tracking past conversations, common hobbies, and co-experienced activities. These indicators contribute to the ongoing personalization of the second user contact's visual depiction so that updates remain reflective of the latest interaction trends. The dynamically adjusted representation allows the first user to engage with the second user contact 145 in a more informed and meaningful manner.

In embodiments, the personalized visual representation 505 enables the first user to tap on each relationship indicator to retrieve more details. For example, when the user taps on the shared activities 526 indicator, it can be segmented into sections such as sports 530, work profile 535, and vacation 540 as illustrated in the figure.

The section ‘510’ of the figure contains a grid of circular icons labeled R1-R9, representing relationship indicators derived from past interactions of the first user and the second user contact. These elements contribute to determining how strongly connected the users are, impacting how prominently the second user contact is displayed via the personalized visual representation. In some embodiments, the system may prioritize the relationship indicators, and the grid of relationship indicators R1-R9 are arranged as per the priority.

Referring to FIG. 5B, FIG. 5B is a schematic illustrating a personalized visual representation of the second user contact with emotional impressions in an embodiment of the disclosed subject matter. The figure explicitly illustrates an embodiment of the system for personalizing user interactions within a networking platform, emphasizing emotionally intelligent and lifelike engagement via holographic technology.

The illustrated embodiment includes the first user 140 interacting with the mobile device 115 to access a social media platform 550. For instance, the social media platform 550 may be Facebook, LinkedIn, Instagram, and the like, which enable individuals to connect, share content, and interact with personal and professional networks. The social media platform 550 comprises a list of second user contacts, including but not limited to a second user contact-A 552, a second user contact-B 554, a second user contact-C 556, and the like.

In embodiments, the social media platform 550 is integrated to the user interaction personalization system 105 that generates three-dimensional holograms of the second user contacts using a holographic projection technology 555. The three-dimensional holograms associated with the second user contacts enable the first user 140 to gain insights into the second user contacts before establishing a connection with them. For instance, the user interaction personalization system 105 retrieves profile data and shared history between the first user 140 and the second user contact-A 552 from the social media platform 550, and optionally from external sources. This data is analyzed to identify one or more relationship indicators, such as prior engagements, shared educational background, emotional interactions, or co-participation in events, and other emotional impressions associated with the combination of the first user 140 and the second user contact-A 552.

The user interaction personalization system 105 interfaces with the mobile device 115 which can render a three-dimensional (3D) hologram 505 of the selected second user contact. The 3D hologram 505 projects from the side as shown, simulating a lifelike presence of the second user contact, in this case, the second user contact-A 552. For instance, the system may generate this 3D hologram 505 in real time in response to a voice command, gesture, or screen interaction by the first user 140.

In embodiments, the projection of the 3D hologram 505 includes one or more visual elements representing emotional impressions or shared memories. The emotional impressions may comprise the lasting, personal feelings or memories evoked in the first user through lifelike holographic projections of second user contacts. These impressions help create a deeper sense of familiarity, trust, and connection beyond traditional text-based profiles. For example, the 3D hologram 505 is projected with one or more emotional impressions or memories, such as images labeled M1 562, M2 564, and M3 568. The image M1 562 depicts a memory of a shared group photo, such as a school group, establishing a common history. The image M2 564 illustrates a celebration moment, for example, a farewell or graduation event, representing emotional bonding. The image M3 568 showcases a direct interaction or conversation between the first user 140 and the second user contact-A 552, a few years ago on one or more networking platforms, representing the personal familiarity.

The emotional impressions, rendered alongside the 3D hologram 505, simulate a more human-like interaction and help the first user 140 build or strengthen a trusted relationship with the second user contact. The 3D hologram 505 not only visualizes the person but may also display associated context, such as affiliations, interests, emotional impressions, and activity history.

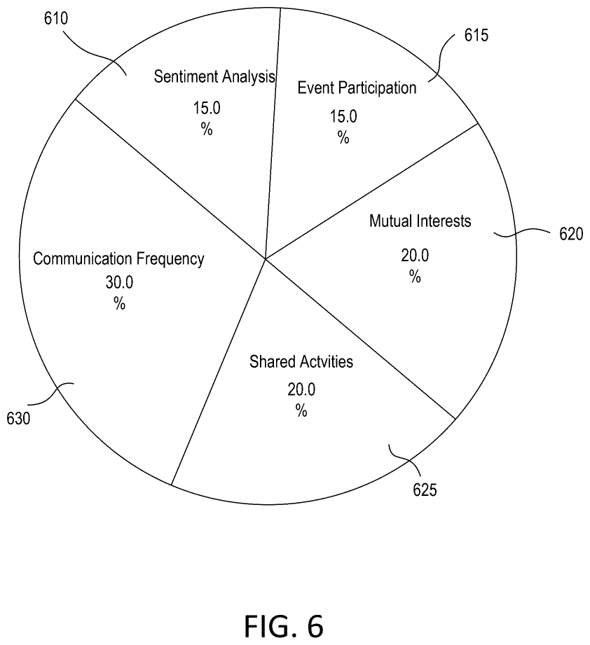

Referring to FIG. 6, FIG. 6 is a schematic illustrating relationship indicators influencing the connection between the first user and the second user contact in an embodiment of the disclosed subject matter. The figure, represented as a pie chart, depicts the contribution of various relationship indicators by percentage. The relationship indicators may comprise sentiment analysis 610, event participation 615, mutual interests 620, shared activities 625, and communication frequency 630. This figure further provides insights into how each relationship indicator impacts the strength and quality of the relationship between the first user and the second user contact.

Among these indicators, the communication frequency 630 holds the highest weightage of about 30%, and this makes it the most significant factor. For instance, the indicated percentages are approximate and may vary with possible deviations of about ±2%. The communication frequency 630 measures how often the first user interacts with the second user contact through messaging, calls, emails, or other communication channels. The higher communication frequency 630 indicates a stronger and more engaged relationship. The shared activities 625 and the mutual interests 620 each contribute about 20% to the relationship strength. For example, the shared activities 625 comprise joint projects, games, hobbies, or collaborative efforts, promoting trust and mutual understanding. Similarly, the mutual interests 620, such as common preferences in music, books, sports, or professional domains, provide a foundation for ongoing interactions and further strengthen the connection.

The remaining percentage of about 30% is split between the sentiment analysis 610 with about 15%, and the event participation with about 15%. The sentiment analysis 610 assesses the tone and emotional context of communications and determines whether interactions are positive, negative, or neutral. A positive sentiment indicates a strong and friendly bond, and a negative sentiment may indicate friction or declining engagement. The event participation 615 measures how often both users attend mutual events, such as meetings, social gatherings, webinars, or virtual events. For example, a higher participation in shared events often signifies a stronger relationship and continued engagement.

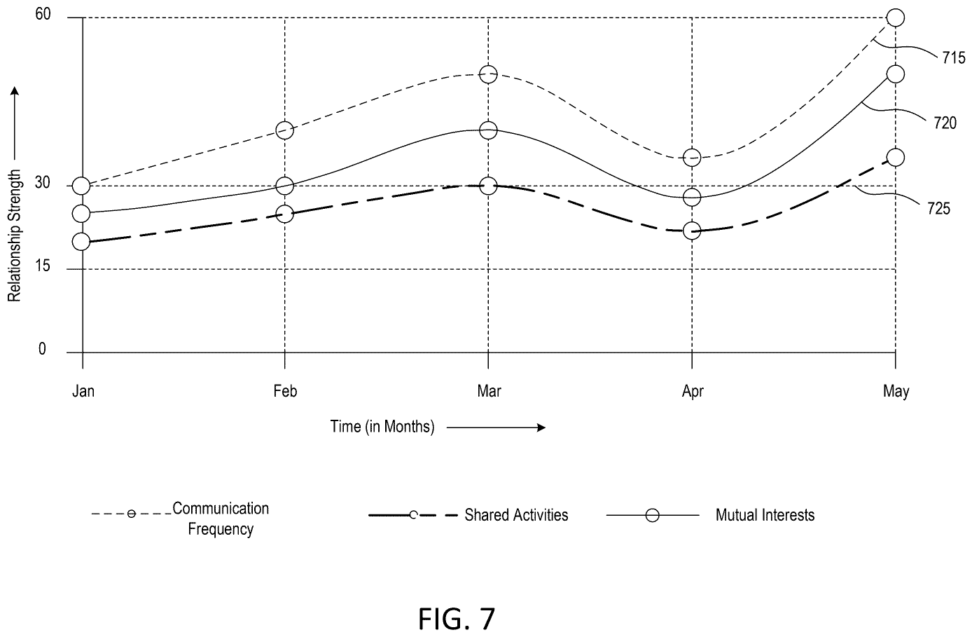

Referring to FIG. 7, FIG. 7 is a schematic illustration of a graph representing trends in relationship indicators in an embodiment of the disclosed subject matter. This figure provides a schematic depiction of the graph illustrating variations in relationship indicators over a period of time. The graph comprises an X-axis representing time in months and a Y-axis representing numerical values corresponding to the strength of relationship indicators. The relationship indicators plotted on the graph comprise communication frequency 715, mutual interests 720, and shared activities 725. Each relationship indicator is depicted with different line styles for clear differentiation.

The communication frequency 715 is represented by a dashed line with circular markers, showing an increasing trend from January to March, a decline in April, and a significant rise in May. This indicator reflects how often the first user interacts with the second user contact within a networking platform. The shared activities 725, illustrated as a solid line with circular markers, also trends upward from January to March, slightly dips in April, and then increases again in May, indicating fluctuations in engagements between the first user and the second user contact. The mutual interests 720, represented by a thick dashed line, follow a steady upward trajectory with a minor dip in April, indicating the evolving alignment of interests between the first user and the second user contact. Based on the tracked indicators, the system adjusts visual attributes such as size, color, animation, or positioning to reflect the changing nature of the relationship.

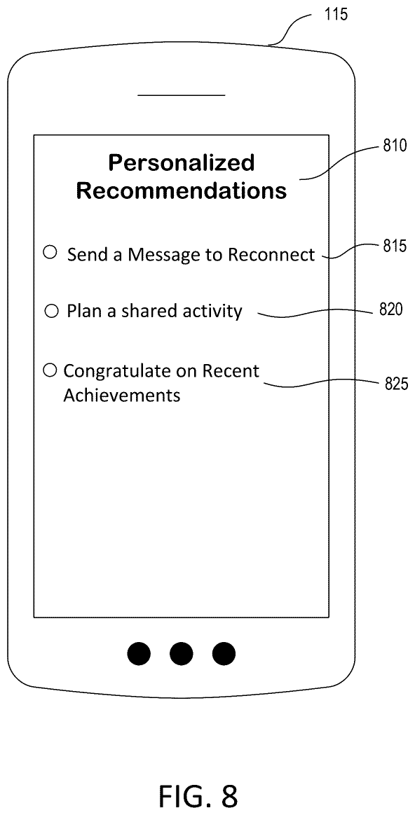

Referring to FIG. 8, FIG. 8 is a schematic illustrating a screenshot of personalized recommendations to improve interaction between a first user and a second user contact in an embodiment of the disclosed subject matter. This figure depicts a schematic representation of a mobile device 115 with a user interface to present personalized recommendations 810 to the first user, improving engagement between the first user and the second user contact.

In one example, the user interface is part of a system implemented to personalize interactions within a networking platform. In another example, the user interface may be integrated with the mobile device 115. The system analyzes relationship indicators such as communication frequency, shared activities, and mutual interests. Based on the analysis, the system dynamically generates one or more personalized recommendations 810 to improve user engagement. These recommendations provide actionable suggestions to improve the connection between the users.

In embodiments, the personalized recommendations 810 displayed on the mobile device 115 include options such as “Send a message to reconnect 815”, “Plan a shared activity 820”, and “Congratulate on recent achievements 825.” These recommendations are personalized based on the retrieved profile data and the history of interactions between the first user and the second user contact. The system continuously updates these recommendations by monitoring changes in relationship indicators and user activity within the networking platform. In some embodiments, the system may modify visual attributes of the recommendations 810 based on priority or urgency, so that the first user is provided with relevant engagement prompts. Through these personalized recommendations 810, the system provides meaningful interactions and strengthens user connections within the digital networking platforms.

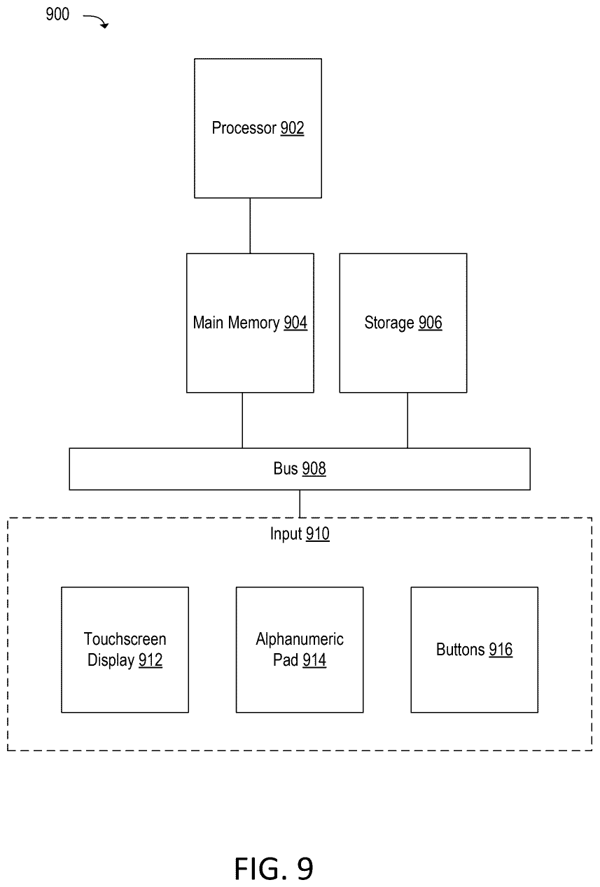

Referring to FIG. 9, FIG. 9 is a block diagram illustrating the computer system 900 that may be implemented in the various embodiments in the described subject matter. The computer system 900 includes a processor 902, main memory 904, storage 906, a bus 908, and input 910. The processor 902 may be one or more processors. The processor 902 executes instructions that are communicated to the processor through the main memory 904. The main memory 904 feeds instructions to the processor 902. The main memory 904 is also connected to the bus 908. The main memory 904 may communicate with the other components of the computer system through the bus 908. Instructions for the computer system 900 are transmitted to the main memory 904 through the bus 908. Those instructions may be executed by the processor 902. Executed instructions may be passed back to the main memory 904 to be disseminated to other components of the computer system 900. The storage 906 may hold large amounts of data and retain that data while the computer system 900 is unpowered. The storage 906 is connected to the bus 908 and can communicate data that the storage holds to the main memory 904 through the bus 908.

The processor 902 may be any type of general purpose processor including, but not limited to a central processing unit (“CPU”), a graphics processing unit (“GPU”), a complex programmable logic device (“CPLD”), a field programmable gate array (“FPGA”), or an application-specific integrated circuit (“ASIC”). One embodiment of the computer system 900 in the ambulatory medical device features a CPU as the processor 902. However, embodiments may be envisioned for the computer system of the ambulatory medical device that incorporate other types of processors 902.

The main memory 904 can be any type of main memory that can communicate instructions to the processor 902 and receive executed instructions from the processor 902. Types of main memory 904 include but are not limited to random access memory (“RAM”) and read only memory (“ROM”). In one embodiment, the computer system 900 incorporates RAM as the form of main memory 904 to communicate instructions to the processor 902 and receive executed instructions from the processor 902. Other embodiments may be envisioned that incorporate other types of main memory 904 in the computer system 900.

The storage 906 can be any type of computer storage that can receive data, store data, and transmit data to the main memory 904 via the bus 908. Types of storage 906 that can be used in the computer system 900 include, but are not limited to, magnetic disk memory, optical disk memory, and flash memory. In one embodiment, flash memory is used as the storage 906 in the computer system 900 of the ambulatory medical device. Other embodiments that use other types of storage 906 for the computer system 900 may be envisioned.

The bus 908 connects the internal components of the computer system 900. The bus 908 may include a multitude of wires that are connected to the components of the computer system 900. The wires of the bus 908 may differ based on the components of the computer system 900 that the bus 908 connects to. In various embodiments, the bus 908 connects the processor 902 to the main memory 904. In various embodiments, the processor 902 is directly connected to the main memory 904.

The input 910 of the computer system 900 includes a touchscreen display 912, an alphanumeric pad 914, and buttons 916. The touchscreen display 912 both produces output and accepts input. The bus 908 may be coupled to the touchscreen display 912 to produce visual output. The touchscreen display 912 may also accept input via capacitive touch, resistive touch, or other touch technology. The input surface of the touchscreen display 912 can register the position of touches on the surface. Some types of touchscreen display 912 can register multiple touches at once. The alphanumeric pad 914 includes a multitude of keys with numerical, alphabetical, and symbol characters. Signals from the alphanumeric pad 914 are communicated by the bus 908 to the main memory 904. Keys of the alphanumeric pad may be capacitive or mechanical. In some embodiments, the alphanumeric pad 914 is displayed on the touchscreen display 912. Buttons 916, such as a meal announcement button, may be capacitive, mechanical, or other single input buttons. or other single input buttons.

Many variations may be made to the embodiments described herein. All variations, including combinations of embodiments, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A system for personalizing user interactions, comprising:
a mobile device, of a first user, configured to provide a personalized visual representation of a second user contact within a networking platform;
a processing unit configured to retrieve profile data associated with the second user contact;
a user interface configured to receive a first user input to interact with the personalized visual representation; and
a personalization engine configured to:
generate the personalized visual representation of the second user contact based on the retrieved profile data and one or more first user preferences;
determine one or more relationship indicators associated with the second user contact based on an interaction history between the first user and the second user contact; and
dynamically update the personalized visual representation by monitoring the one or more relationship indicators.

2. The system of claim 1, wherein the mobile device is configured to provide the personalized visual representation as a three-dimensional hologram.

3. The system of claim 1, wherein the processing unit is further configured to retrieve real-time activity data associated with the second user contact from one or more external platforms.

4. The system of claim 1, wherein the one or more relationship indicators comprise at least one of a communication frequency, shared activities, mutual interests, event participation, and sentiment derived from prior communications.

5. The system of claim 1, wherein the personalization engine is further configured to modify a visual attribute of the personalized visual representation based on changes to the one or more relationship indicators.

6. The system of claim 5, wherein the visual attribute includes at least one of a color, size, animation effects, positioning, and graphical overlays representing connection strength between the first user and the second user contact.

7. The system of claim 1, wherein the personalization engine is configured to dynamically update the personalized visual representation based on user-generated content, shared media, or real-time updates of the second user contact within the networking platform.

8. The system of claim 1, wherein the personalization engine is further configured to provide one or more recommendations to the first user for improving engagement with the second user contact based on changes in the one or more relationship indicators.

9. The system of claim 1, wherein the personalization engine is further configured to generate one or more visual indicators within the personalized visual representation to indicate upcoming events, milestones, or recommended actions for further engagement with the second user contact.

10. The system of claim 1, wherein the personalization engine is further configured to categorize the second user contact based on the one or more relationship indicators.

11. A method for personalizing user interactions, comprising:
retrieving profile data associated with a second user contact within a networking platform;
generating, by a personalization engine, a personalized visual representation of the second user contact based on the retrieved profile data and one or more first user preferences;
providing a personalized visual representation of the second user contact on a mobile device of a first user;
determining one or more relationship indicators associated with the second user contact based on an interaction history between the first user and the second user contact; and
dynamically updating the personalized visual representation by monitoring the one or more relationship indicators.

12. The method of claim 11, wherein the mobile device is configured to provide the personalized visual representation as a three-dimensional hologram.

13. The method of claim 11, further comprises retrieving real-time activity data associated with the second user contact from one or more external platforms.

14. The method of claim 11, wherein the one or more relationship indicators comprise at least one of a communication frequency, shared activities, mutual interests, event participation, and sentiment derived from prior communications.

15. The method of claim 11, wherein the personalization engine is further configured to modify a visual attribute of the personalized visual representation based on changes to the one or more relationship indicators.

16. The method of claim 15, wherein the visual attribute includes at least one of a color, size, animation effects, positioning, and graphical overlays representing connection strength between the first user and the second user contact.

17. The method of claim 11, wherein the personalization engine is configured to dynamically update the personalized visual representation based on user-generated content, shared media, or real-time updates of the second user contact within the networking platform.

18. The method of claim 11, wherein the personalization engine is further configured to provide one or more recommendations to the first user for improving engagement with the second user contact based on changes in the one or more relationship indicators.

19. The method of claim 11, wherein the personalization engine is further configured to generate one or more visual indicators within the personalized visual representation to indicate upcoming events, milestones, or recommended actions for further engagement with the second user contact.

20. A non-transitory computer readable storage medium having data stored therein representing software executable by a computer system, the software comprising instructions that, when executed, cause the non-transitory computer readable storage medium to perform a method comprising:
retrieving profile data associated with a second user contact within a networking platform;
generating a personalized visual representation of the second user contact based on the retrieved profile data and one or more first user preferences;
providing a personalized visual representation of a second user contact on a mobile device of a first user;
determining one or more relationship indicators associated with the second user contact based on an interaction history between the first user and the second user contact; and
dynamically updating the personalized visual representation by monitoring the one or more relationship indicators.
